(19) United States
(12) Patent Application Publication
(10) Pub. No.: US 2005/0029028 A1
(43) Pub. Date: Feb. 10, 2005

(54) Radiator debris guard

(76) Inventor: Brian Lance Steinmacher, Bellaire, MI (US)

Correspondence Address: Brian Lance Steinmacher, 2295 Orchard Hill Road, Bellaire, MI, 49615, US

(21) Appl. No.: 10/634,672

(22) Filed: Aug. 6, 2003

(51) Int. Cl. B60K 11/04

(52) U.S. Cl. 180/68.6

(57) ABSTRACT

The Radiator Debris Guard was invented to keep bugs and debris from damaging the radiator. The guard will also prolong the life of the radiator and keep it cosmetically attractive. Made of aluminum, it will be lightweight, will not rust, and will not overheat the radiator. They will use the existing radiator brackets, so car owners will not have to drill extra holes to make it fit the vehicle they own. Each radiator guard will be fit to the dimensions of the specific car. The guard is easily removed for cleaning and for car shows. Each guard will be made of heavy-duty aluminum screening material for longer life.

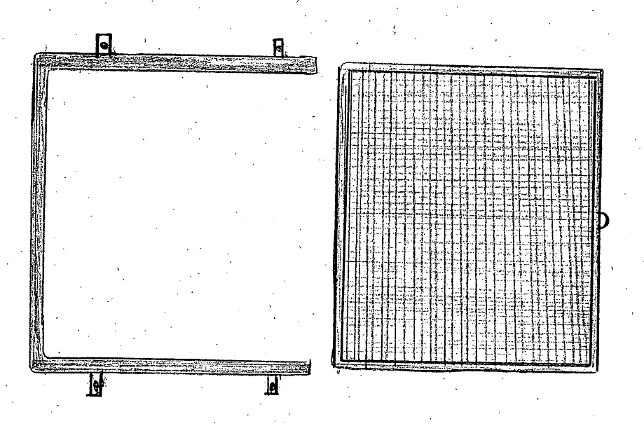

The purpose of the Radiator Debris Guard is to protect the radiator of your car. It is placed in the front of the radiator and bolted to the radiator stabilizer, with stabilizer adjustable brackets. The screen can then be removed for car shows, and for cleaning. The frame and the screen frame are made with heavy gage aluminum, and the screen of heavy-duty screen material to keep foreign objects from ruining the cosmetics of the radiator.

### CROSS REFERENCE TO RELATED APPLICATIONS

None noted

### STATEMENT REGARDING FEDERALLY SPONSORED RESEARCH AND DEVELOPMENT

None Noted

### BACKGROUND OF THE INVENTION

Having seven classic cars and trucks and the expense of restoration, I needed a way to keep the interior and exterior engine compartment clean and keep my radiators in show worthy condition. For not only cosmetic purposes, it will extend the radiator longevity.

### BRIEF SUMMARY OF THE INVENTION

This is a screen that fits into a framework in front of the radiator of a car to protect the radiator and engine from bugs and debris that clog the radiator and front of the car.

### DETAILED DESCRIPTION OF THE INVENTION

This guard will be designed specific for each model with spacer washers for an ideal fit. The screen has a handle for easy removal. All materials are of aluminum so it will not add to the temperature of the radiator and will not rust.

The protecting screen has mitered corners stabilized by corner inserts that are tamped in place. Next the aluminum screen material is rolled into the spline groove and then the spline material rolled in.

The screen frame is made of aluminum framing material. Most cars will require only 2 side screen slides. Each side has an adjustable bracket that will be bolted to the radiator stabilizer frame on the car to sit in front of the radiator. Adjustments can be made using washers for a perfect fit. If needed, a bottom bracket will be welded on using corner stabilizers. The brackets will utilize the existing radiator support holes. A longer bolt may be needed on some cars to make up for the bracket thickness.

The screen slides in the spline groove of the frame to fit in front of the radiator blocking bugs and debris from damaging the radiator front. The screen can be removed with the pull handle for show purposes.

1. What I claim as my invention is a bolt in radiator debris screen, which will prevent stones and bugs from damaging the radiator and engine of a car. This screen can be fit to the front of each model of car or truck it is specifically designed for.
